(19) United States
(12) Patent Application Publication
(10) Pub. No.: US 2006/0279055 A1
(43) Pub. Date: Dec. 14, 2006

(54) Skateboard with integral handle

(76) Inventor: Terry Morabito, Locust Valley, NY (US)

Correspondence Address: BODNER & O'ROURKE, LLP, 425 BROADHOLLOW ROAD, SUITE 108, MELVILLE, NY, 11747, US

(21) Appl. No.: 11/449,346

(22) Filed: Jun. 8, 2006

Related U.S. Application Data
(60) Provisional application No. 60/688,979, filed on Jun. 9, 2005.

(51) Int. Cl. B62M 1/00

(52) U.S. Cl. 280/87.042

(57) ABSTRACT

A skateboard having an integral handle includes a deck, trucks mounted on the deck and wheels rotatably mounted on the trucks. The skateboard further includes several handles for grasping by the skateboard user in the performance of stunts and to facilitate carrying the skateboard. The handles are integral with the skateboard and defined by openings formed through the thickness of the skateboard deck. The handle openings are situated slightly inwardly from each of the front edge and the rear edge of the skateboard deck, and slightly inwardly from the opposite lateral edges of the skateboard deck.

### CROSS REFERENCE TO RELATED APPLICATION

This application is related to U.S. provisional application Ser. No. 60/688,979, filed on Jun. 9, 2005, and entitled “Skateboard With Integral Handle”, the disclosure of which is incorporated herein by reference. This application claims the benefit of priority under 35 U.S.C. 119 and/or 120 to the aforementioned related provisional application.

### BACKGROUND OF THE INVENTION

1. Field of the Invention The present invention relates to skateboards, and more particularly relates to skateboards and methods and means for handling the same.

2. Description of the Prior Art

Conventional skateboards used as sports equipment have a skateboard deck which is grasped by the user when carrying the board or when performing stunts, such as jumps, on the skateboard. With conventional skateboards, the user receives cuts and splinters by grasping the skateboard deck. This is one way in which the conventional skateboard is presently used or carried. Another way is for the user to grasp the trucks. Trucks are the components on which the wheels are fastened to the skateboard deck. By doing this, the user can also incur cuts on his fingers from the truck screws. The edges of the skateboard deck become rough through use and, because this is the most common way to handle the skateboard, the user incurs cuts and splinters on his hand. A conventional skateboard is disclosed in U.S. Pat. No. 6,648,363, which issued to Shale Gordon, the disclosure of which is incorporated herein by reference.

### OBJECTS AND SUMMARY OF THE INVENTION

It is an object of the present invention to provide a skateboard having a handle formed integrally therewith.

It is another object of the present invention to provide a skateboard that is easy to handle when performing stunts and when carrying the skateboard.

It is a further object of the present invention to provide a skateboard that overcomes the inherent disadvantages of known skateboards.

In accordance with one form of the present invention, a skateboard includes a deck having an upper surface and a lower surface opposite the upper surface, a pair of trucks spaced apart from one another and mounted on the lower surface of the deck, and wheels mounted on the trucks. The skateboard further includes one or more handles formed integrally with the skateboard.

More specifically, the handle or handles are preferably one or more openings formed through the thickness of the skateboard deck. The openings are formed slightly inwardly from the lateral edges of the skateboard deck and slightly inwardly from each of the front edge and a rear edge of the skateboard deck. Because the handle openings are set inwardly of the skateboard edges, they will not be subjected to the wear and tear that the edges of the skateboard deck experience.

The skateboard deck may also include writing in the middle of the board between the trucks, or elsewhere. Preferably, the writing is cut all the way through the thickness of the skateboard deck. The writing may be a logo or a personal name, for example. By cutting the logo or personal name through the thickness of the skateboard deck, the writing becomes permanent and is visible at all times, even when the skateboard rider is using the skateboard on a half pipe doing flips.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1 is a perspective view of a skateboard with integral handles formed in accordance with the present invention.

FIG. 2 is a cross-sectional view of a skateboard formed in accordance with the present invention and shown in FIG. 1, taken along line 2-2 of FIG. 1.

FIG. 3 is a cross-sectional view of a skateboard formed in accordance with the present invention and shown in FIG. 1, taken along line 3-3 of FIG. 1.

### DETAILED DESCRIPTION OF THE PREFERRED EMBODIMENTS

There are numerous types of skateboard decks currently on the market, and none has an integral handle. The skateboard of the present invention includes all of the conventional and basic components of a currently marketed skateboard, including a skateboard deck, trucks and wheels mounted on the trucks, such as shown and described in the aforementioned U.S. Pat. No. 6,648,363. However, in accordance with the present invention, a handle or handles are provided on the skateboard deck.

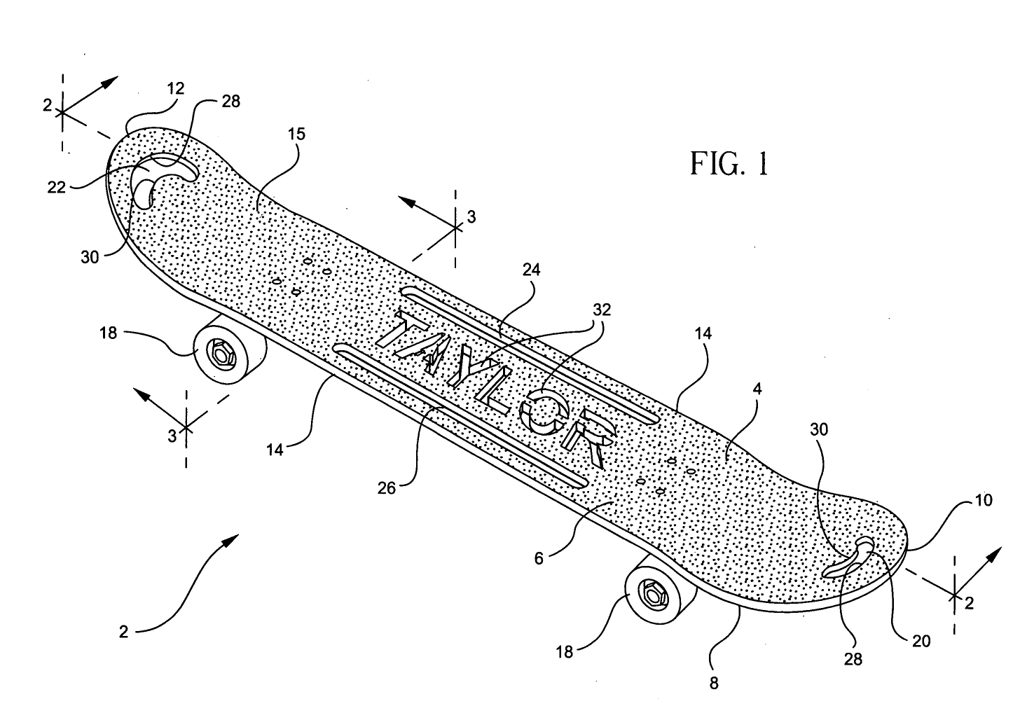

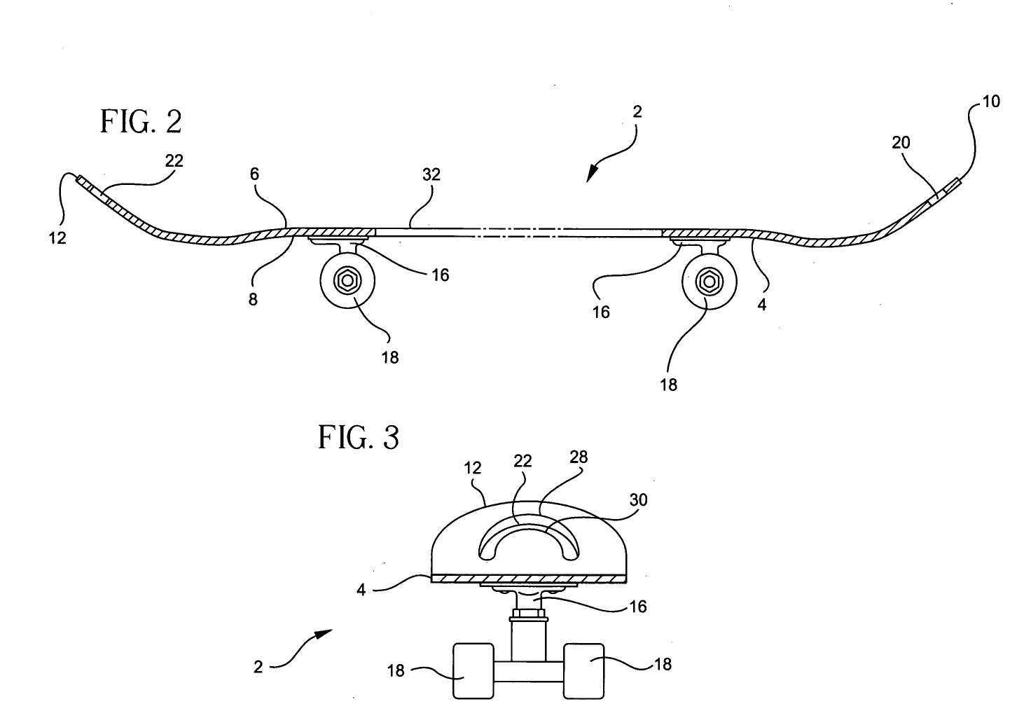

More specifically, and as shown in FIGS. 1-3 of the drawings, it will be seen that a skateboard 2 constructed in accordance with the present invention includes a deck 4 having an upper surface 6 and a lower surface 8 opposite the upper surface 6, and further having a front edge 10, a rear edge 12 situated opposite the front edge 10, and opposite lateral edges 14. The deck 4 may be formed from wood, such a plywood, fiberglass or other materials known to one skilled in the art of making skateboards. The upper surface 6 of the deck may have a non-slip, sandpaper-like surface 15 adhesively applied thereto for the safety of the skateboard rider and to facilitate the rideability of the skateboard.

The skateboard 2 further includes trucks 16 mounted on the lower surface 8 of the skateboard and spaced apart from each other along the longitudinal axis of the skateboard, and wheels 18 rotatably mounted on the trucks 16.

The skateboard 2 of the present invention advantageously includes one or more handles formed integrally therewith. More specifically, the handle or handles are preferably one or more openings 20, 22, 24, 26 formed through the thickness of the skateboard deck 4. The openings 20, 22, 24, 26 may be formed slightly inwardly from the lateral edges 14 of the skateboard deck, and slightly inwardly from each of the front edge 10 and the rear edge 12 of the skateboard deck. The handles will preferably have the same contour as the front or rear edges 10, 12 of the deck, such as having a concave shape on the front or back edge 28, 30 of the opening 20, 22, 24, 26. Preferably, the inside edges of the openings 20, 22, 24, 26 will be rounded and smooth to prevent splinters and to promote easy handling of the skateboard. The handles, that is, the openings 20, 22, 24, 26, will always remain smooth because they never come in contact with any surface when the skateboard 2 is being ridden. That is, the edges of the skateboard are always grinding against rough surfaces, causing splinters. However, because the handle openings 20, 22, 24, 26 are set inwardly of the skateboard edges 10, 12, 14, they will not be subjected to the wear and tear that the edges of the skateboard deck 4 experience.

The handle openings 20, 22 in the front and rear of the skateboard deck 4 are preferably about four inches long and about an inch and a quarter in width. The handle openings 24, 26 on the lateral sides 14 of the skateboard deck are preferably four to sixteen inches long. When a skateboarder flips the nose (i.e., the front of the skateboard 2) up by using the handle openings, it makes it easier for the user to grasp the skateboard when performing stunts. The handle openings 20, 22, 24, 26 also facilitate the carrying of the skateboard by the user.

Because the openings 20, 22, 24, 26 are part of the board 2 and are formed integrally with it, there are no additional materials of any kind needed to manufacture the handle and to incorporate it on the skateboard deck 4. Accordingly, there is no added material which extends or protrudes from the skateboard deck 4 that would create a hazard.

The skateboard deck 4 may also include writing 32 in the middle of the board 2 between the trucks 16, or elsewhere on the skateboard. Preferably, the writing 32 is cut all the way through the thickness of the skateboard deck 4. This writing 32 will or could be a logo, word or a personal name. Conventional skateboards use a sticker adhesively affixed to the underside of the skateboard deck, which sticker is not visible when the skateboard is in its normal operating position. Also, the conventional sticker is usually scraped away when the board is used initially. By cutting the logo or personal name through the thickness of the skateboard deck 4, the writing 32 becomes permanent and is visible at all times, even when on a half pipe doing flips. The logo or name cut through the board will be permanent and can be seen from either the top or bottom of the skateboard.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A skateboard having an integral handle, which comprises:
a skateboard deck, the skateboard deck having an upper surface and a lower surface opposite the upper surface, a front edge, an opposite rear edge, and opposite lateral edges;
a pair of trucks mounted on the lower surface of the skateboard deck and spaced apart from each other;
wheels rotatably mounted on the trucks; and
at least one handle, the at least one handle being defined as an opening formed through the thickness of the skateboard deck, the at least one handle opening being graspable by a user of the skateboard.

2. A skateboard as defined by claim 1, wherein the at least one handle opening is formed near the front edge of the skateboard deck.

3. A skateboard as defined by claim 2, wherein the skateboard deck defines a front edge and a back edge to the at least one skateboard opening, and wherein at least one of the front edge and the back edge of the at least one handle opening has a concave shape.

4. A skateboard as defined by claim 1, wherein the at least one handle opening is formed near the rear edge of the skateboard deck.

5. A skateboard as defined by claim 4, wherein the skateboard deck defines a front edge and a back edge to the at least one skateboard opening, and wherein at least one of the front edge and the back edge of the at least one handle opening has a concave shape.

6. A skateboard as defined by claim 1, wherein the at least one handle includes a first and second handle, each of which is defined by openings formed through the thickness of the skateboard deck and positioned partially inwardly of the opposite lateral edges of the skateboard deck.

7. A skateboard as defined by claim 1, which further comprises:
a writing, the writing being defined as a cutout formed through the thickness of the skateboard deck.

8. A skateboard as defined by claim 7, wherein the writing is positioned in the middle of the skateboard between the trucks thereof.

9. A skateboard as defined by claim 7, wherein the writing defines one of logo, word and personal name.

10. A skateboard having an integral handle, which comprises:
a skateboard deck, the skateboard deck having an upper surface and a lower surface opposite the upper surface, a front edge, a rear edge opposite the front edge, and opposite lateral edges;
a pair of trucks mounted on the lower surface of the skateboard deck and spaced apart from one another;
wheels rotatably mounted on the trucks; and
a plurality of handles integrally formed with the skateboard, the handles being defined by openings formed through the thickness of the skateboard deck, the openings including a first opening disposed near the front edge of the skateboard deck, a second opening disposed near the rear edge of the skateboard deck, a third opening disposed near one lateral edge of the skateboard deck, and a fourth opening disposed near the other lateral edge of the skateboard deck.

11. A skateboard as defined by claim 10, which further comprises a writing situated in the middle of the skateboard between the trucks thereof, the writing being defined by a cutout formed through the thickness of the skateboard deck.
